(19) United States
(12) Patent Application Publication
(10) Pub. No.: US 2018/0253045 A1
(43) Pub. Date: Sep. 6, 2018

(54) IMAGE FORMING APPARATUS

(71) Applicant: Konica Minolta, Inc., Tokyo (JP)

(72) Inventors: Tomoyoshi Yukimoto, Nagoya-shi (JP); Masayuki Satou, Toyohashi (JP); Taisuke Minemura, Okazaki-shi (JP); Yoshiyuki Toso, Toyokawa-shi (JP); Shoichi Yoshikawa, Okazaki-shi (JP)

(21) Appl. No.: 15/900,190

(22) Filed: Feb. 20, 2018

(30) Foreign Application Priority Data
Mar. 1, 2017 (JP) 2017-037847

(51) Int. Cl. G03G 15/20

(52) U.S. Cl. CPC G03G 15/2078; G03G 15/2017

(57) ABSTRACT

An image forming apparatus includes a fixing part that fixes an unfixed toner image transferred to a sheet of paper by a fixing member being heated, a duct having an inner opening facing the fixing member and an outer opening spaced apart from the fixing member, a fan capable of changing a flow direction of air inside the duct, a filter that collects particulates flowing inside the duct, and a hardware processor that controls the fan to rotate in a direction to draw air into the duct from the inner opening to collect the particulates from a vicinity of the fixing member, and that, at a timing at which to cool the fixing member, controls the fan to rotate in a direction to blow air inside the duct toward the fixing member from the inner opening.

The entire disclosure of Japanese patent Application No. 2017-037847, filed on Mar. 1, 2017, is incorporated herein by reference in its entirety.

### BACKGROUND

### Technological Field

The present invention relates to an image forming apparatus.

### Description of the Related Art

Image forming apparatuses such as copying machines, printers, and facsimiles are known to generate particulates such as ultra fine particles (UFP). It is also known that these particulates are easily generated particularly in fixing parts. JP 2011-180341 A discloses an example of a conventional image forming apparatus proposed for collecting particulates.

The image forming apparatus disclosed in JP 2011-180341 A includes an exhaust duct that has an inlet facing the outer peripheral surface of a fixing member, a filter that captures particulates flowing through the exhaust duct, and a cooling duct that has an outlet facing a sheet (sheet of paper). This image forming apparatus collects the particulates generated from the fixing member with the filter and cools the sheet. The image forming apparatus thus prevents the particulates from being discharged externally, and further prevents melting of toner after the sheet of paper is cooled and the toner is fixed thereon.

It has been known that printing sheets of paper of a relatively small size continuously in an image forming apparatus increases the difference in temperature between a paper passing portion and a non-paper passing portion on a surface of a fixing member. This difference in temperature on the surface of the fixing member may affect fixing in subsequent printing of larger sheets of paper, causing image noise on a printed matter.

It is thus considered desirable to cool the fixing member to bring the whole fixing member to a uniform temperature and to prevent the temperature of the whole fixing member from rising excessively. By cooling the fixing member, suppression of variations in a fixing nip width caused by thermal expansion of the fixing member and suppression of degradation of the fixing member can also be expected.

Although the image forming apparatus disclosed in JP 2011-180341 A cools the sheet (sheet of paper) in addition to collecting the particulates, this image forming apparatus does not actively cool the fixing member itself. As a result, there remain issues regarding generation of image noise, variations in the fixing nip width, and degradation of the fixing member.

### SUMMARY

The present invention has been made in view of the above problems, and it is an object of the present invention to provide an image forming apparatus which can efficiently collect particulates and effectively cool a fixing member.

To achieve the abovementioned object, according to an aspect of the present invention, an image forming apparatus reflecting one aspect of the present invention comprises: a fixing part that fixes an unfixed toner image transferred to a sheet of paper by a fixing member being heated; a duct having an inner opening facing the fixing member and an outer opening spaced apart from the fixing member; a fan capable of changing a flow direction of air inside the duct; a filter that collects particulates flowing inside the duct; and a hardware processor that controls the fan to rotate in a direction to draw air into the duct from the inner opening to collect the particulates from a vicinity of the fixing member, and that, at a timing at which to cool the fixing member, controls the fan to rotate in a direction to blow air inside the duct toward the fixing member from the inner opening.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a partial vertical cross-sectional front view of an image forming apparatus of a first embodiment of the present invention;

FIG. 2 is a front view showing a fixing part and a blower of the image forming apparatus of the first embodiment of the present invention;

FIG. 3 is a graph showing the relationship between the heated roller temperature and a UFP generation rate of the image forming apparatus of the first embodiment of the present invention;

FIG. 4 is a timing diagram of the start of operation of the image forming apparatus of the first embodiment of the present invention;

FIG. 5 is a timing diagram of the start of operation of an image forming apparatus of a second embodiment of the present invention;

FIG. 6 is a partial front view showing a fixing part and a blower (in an inner valve closed state) of an image forming apparatus of a third embodiment of the present invention;

FIG. 7 is a top view showing the blower (in the inner valve closed state) of the image forming apparatus of the third embodiment of the present invention;

FIG. 8 is a partial front view showing the fixing part and the blower (in an inner valve open state) of the image forming apparatus of the third embodiment of the present invention;

FIG. 9 is a top view showing the blower (in the inner valve open state) of the image forming apparatus of the third embodiment of the present invention;

FIG. 10 is a timing diagram of the start of operation of the image forming apparatus of the third embodiment of the present invention;

FIG. 11 is a diagram showing operating modes of the blower of the image forming apparatus of the third embodiment of the present invention;

FIG. 12 is timing diagram during steady-state operation of the image forming apparatus of the third embodiment of the present invention;

FIG. 13 is a partial front view showing a fixing part and a blower (in an inner valve closed state) of an image forming apparatus of a fourth embodiment of the present invention;

FIG. 14 is a partial front view showing the fixing part and the blower (in an inner valve open state) of the image forming apparatus of the fourth embodiment of the present invention;

FIG. 15 is a partial front view showing a fixing part and a blower (in a first outer valve open state) of an image forming apparatus of a fifth embodiment of the present invention;

FIG. 16 is a top view of the blower (in the first outer valve open state) of the image forming apparatus of the fifth embodiment of the present invention;

FIG. 17 is a partial front view showing the fixing part and the blower (in a second outer valve open state) of the image forming apparatus of the fifth embodiment of the present invention; and

FIG. 18 is a top view showing the blower (in the second outer valve open state) of the image forming apparatus of the fifth embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

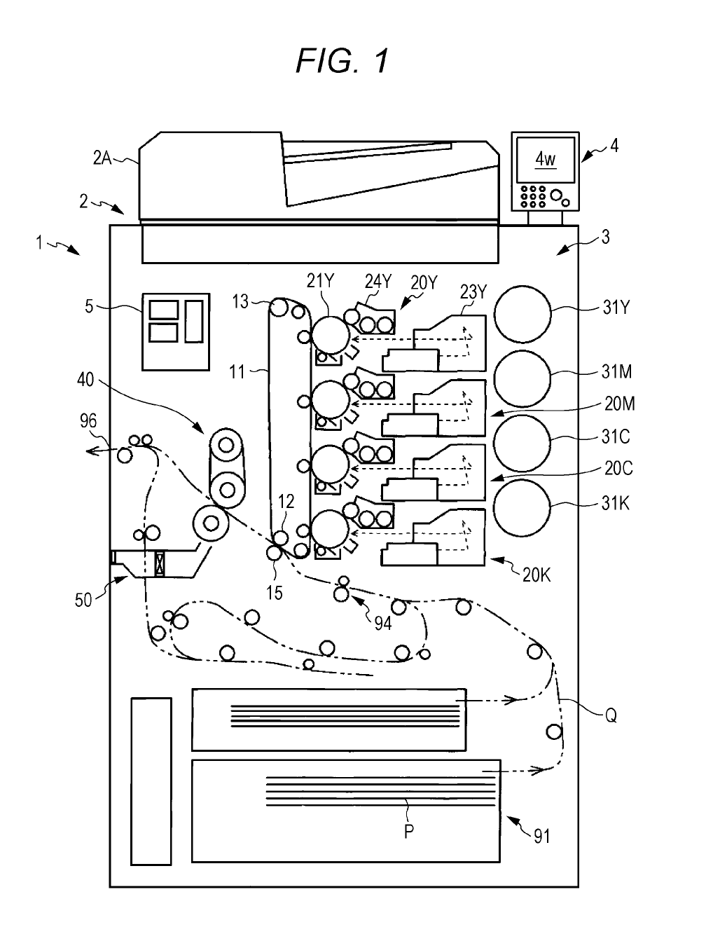

With reference to FIG. 1, the structure of an image forming apparatus of a first embodiment of the present invention is schematically described, with an image output operation thereof also described. FIG. 1 is an example of a partial vertical cross-sectional front view of the image forming apparatus. The dash-dot-dot lines with arrows in FIG. 1 represent transport paths and transport directions of sheets of paper. The up-down direction, left-right direction, and the direction into and out of the drawing in FIG. 1 is the up-down direction, left-right direction, and depth direction of the image forming apparatus, respectively.

An image forming apparatus 1 is a tandem color copying machine as shown in FIG. 1, and includes an image reading unit 2 that reads an image of a document, a printing unit 3 that prints the read image on a transfer material such as a sheet of paper, an operation unit 4 that inputs printing conditions and displays operational status, and a main controller 5.

The image reading unit 2 is a publicly known unit that reads the image of a document placed on a top surface of a platen glass (not shown) by moving a scanner (not shown). The image forming apparatus 1 can also automatically read images of a plurality of documents one by one using a document transport device 2A. The image of the document is separated into three colors, i.e., red (R), green (G), and blue (B), and converted into electrical signals by a charge coupled device (CCD) image sensor (not shown). The image reading unit 2 thus obtains color-specific image data for red (R), green (G), and blue (B).

The color-specific image data obtained by the image reading unit 2 is subjected to various processes in the main controller 5 and converted into image data of reproduction colors, i.e., yellow (Y), magenta (M), cyan (C), and black (K), to be stored in a memory (not shown) such as of the main controller 5. The image data of each reproduction color stored in the memory is subjected to a process for correcting misalignment, and then read out for each scan line in synchronization with the transport of a sheet of paper, in order to optically scan a photoconductor drum 21, which is an image carrier.

The printing unit 3 electrophotographically forms an image and transfers that image to the sheet of paper. The printing unit 3 includes an intermediate transfer belt 11, which is an intermediate transfer member formed as an endless belt. The intermediate transfer belt 11 is wound around a plurality of rollers including a driving roller 12 and a driven roller 13. The intermediate transfer belt 11 moves rotationally in a clockwise direction in FIG. 1 by the driving roller 12.

The driving roller 12 presses against and contacts a secondary transfer roller 15 on an opposite side of the intermediate transfer belt 11. On the downstream side of a rotation direction of the intermediate transfer belt 11 at the position of the secondary transfer roller 15, an intermediate transfer cleaning unit (not shown) is provided in contact with an outer peripheral surface of the intermediate transfer belt 11. The intermediate transfer cleaning unit removes deposits such as toner remaining on the outer peripheral surface of the intermediate transfer belt 11 to clean the intermediate transfer belt 11 after a toner image formed on the outer peripheral surface of the intermediate transfer belt 11 is transferred to the sheet of paper.

Image forming units 20Y, 20M, 20C, and 20K, which correspond to the reproduction colors of yellow (Y), magenta (M), cyan (C), and black (K), are mounted on the right side of the intermediate transfer belt 11 as viewed from the front. In this description, the image forming units 20Y, 20M, 20C, and 20K may be collectively called, for example, the “image forming unit 20” without the identification letters of “Y,” “M,” “C,” and “K” that represent the respective colors, unless it is necessary to distinguish them. The four image forming units 20 are arranged in a row along the rotation direction of the intermediate transfer belt 11 from the upstream side toward the downstream side of the rotation direction. The four image forming units 20 all have the same configuration, and each include a charge unit, an exposure unit 23, a developing unit 24, a drum cleaning unit, and a primary transfer roller, centered around the photoconductor drum 21 that rotates in a counterclockwise direction in FIG. 1.

Toner bottles 31 that correspond to the respective reproduction colors are provided on the right side of the four image forming units 20 as viewed from the front. Each toner bottle 31 contains new unused toner therein that is supplied individually to each developing unit 24. The toner bottles 31 are removably mounted on an apparatus body and can be replaced with new ones as required.

A paper feed device 91 is provided below the image forming apparatus 1. The paper feed device 91 houses a stack of a plurality of sheets of paper P therein and feeds the sheets of paper P in turn one by one from the top of the stack to a paper transport path Q. Each sheet of paper P fed to the paper transport path Q from the paper feed device 91 reaches the position of a registration roller pair 94. The registration roller pair 94 corrects diagonal feeding (skew correction) of the sheet of paper P while feeding the sheet of paper P, in synchronization with the rotation of the intermediate transfer belt 11, to a contact portion (secondary transfer nip) between the intermediate transfer belt 11 and the secondary transfer roller 15.

In each image forming unit 20, an electrostatic latent image is formed on a surface of the photoconductor drum 21 by light emitted from the exposure unit 23, and the electrostatic latent image is visualized as a toner image by the developing unit 24. The toner image formed on the surface of the photoconductor drum 21 is primarily transferred to the outer peripheral surface of the intermediate transfer belt 11 at a position at which the photoconductor drum 21 faces the primary transfer roller on an opposite side of the intermediate transfer belt 11. The toner images of the image forming units 20 are transferred successively to the intermediate transfer belt 11 at a predetermined timing, along with the rotation of the intermediate transfer belt 11, to form a superimposed color toner image of the four colors, i.e., yellow, magenta, cyan, and black, on the outer peripheral surface of the intermediate transfer belt 11.

The color toner image primarily transferred to the outer peripheral surface of the intermediate transfer belt 11 is then transferred to the sheet of paper P, which is fed from the registration roller pair 94 in synchronization with the rotation of the intermediate transfer belt 11, at the secondary transfer nip that is formed by the intermediate transfer belt 11 contacting the secondary transfer roller 15.

A fixing part 40 is provided on a downstream side of the secondary transfer nip in a paper transport direction. The sheet of paper P to which the unfixed toner image has been transferred at the secondary transfer nip is fed to the fixing part 40 where the toner image is heated and pressurized to be fixed to the sheet of paper P. The sheet of paper P that has passed through the fixing part 40 passes through a paper outlet 96, which is provided on a left-side surface of the body of the image forming apparatus 1, and is discharged to a paper outlet tray (not shown) provided outside the paper outlet 96.

The operation unit 4 is mounted on the right side of the image reading unit 2. The operation unit 4 receives, for example, user input of settings including printing conditions such as the type and size of the sheets of paper P used for printing, scaling, whether duplex printing is to be used, and of settings including facsimile numbers and sender names for sending facsimiles. The operation unit 4 also acts as a notification unit for notifying the user of the status of the apparatus, precautions, error messages, and the like, by displaying them on a display 4w.

The image forming apparatus 1 is also provided with the main controller 5 that includes a central processing unit (CPU) and an image processing unit, which are not shown, and other electronic components (also not shown), for overall operational control. The main controller 5 utilizes the CPU and the image processing unit to control elements, such as the image reading unit 2 and the printing unit 3, based on programs and data input and stored in the memory to implement a series of image forming operations and printing operations.

The image forming apparatus 1 includes a blower 50 as shown in FIG. 1. The blower 50 is arranged in an area from below the fixing part 40 to the left-side surface of the body of the image forming apparatus 1. The blower 50 draws in and collects particulates (UFP) suspended inside the image forming apparatus 1, especially around the fixing part 40. Additionally, the blower 50 blows air toward the fixing part 40 to cool fixing members.

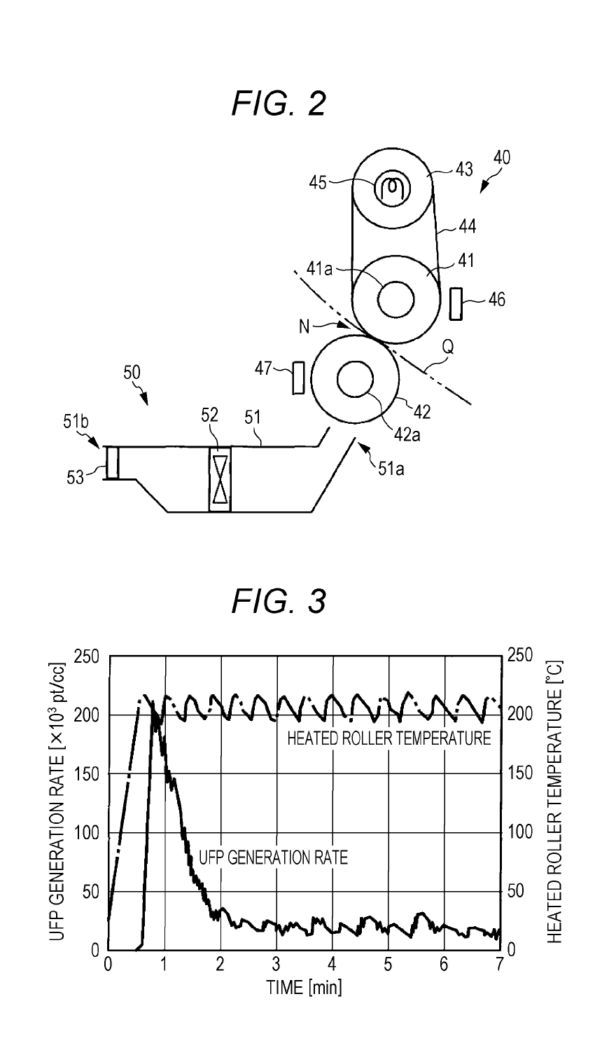

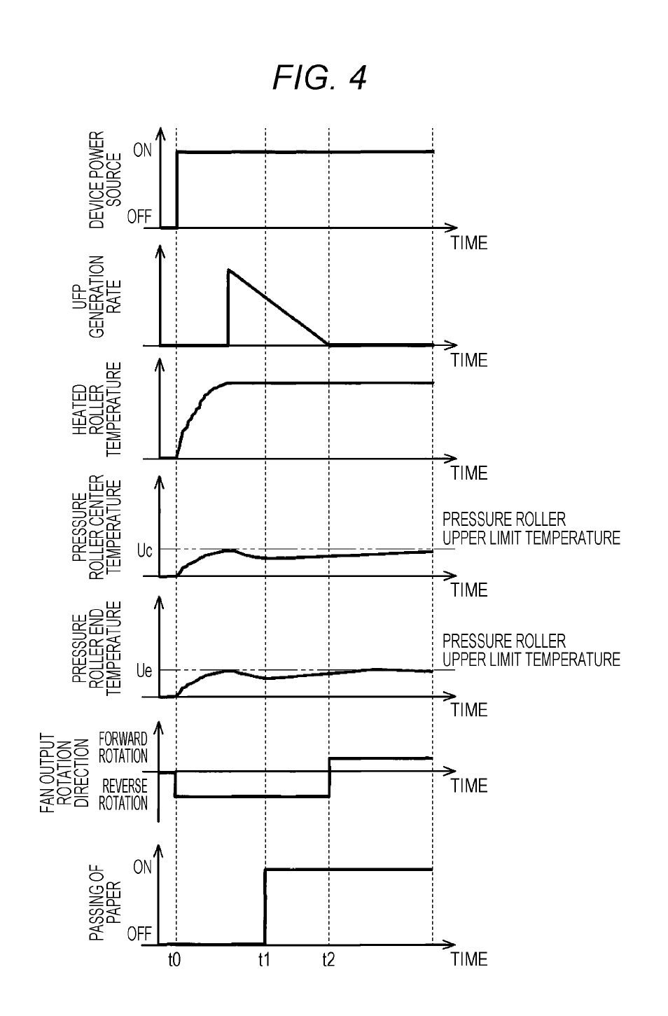

Detailed construction and operation of the fixing part 40 and the blower 50 of the image forming apparatus 1 will be described next with reference to FIGS. 2 to 4. FIG. 2 is a front view showing the fixing part 40 and the blower 50. FIG. 3 is a graph showing the relationship between the heated roller temperature and a UFP generation rate. FIG. 4 is a timing diagram of the start of operation of the image forming apparatus 1.

The fixing part 40 includes, as shown in FIG. 2, a fixing roller 41, a pressure roller 42, a heated roller 43, a fixing belt 44, and a heating unit 45, which are the fixing members, and temperature sensors 46 and 47.

The fixing roller 41 and the pressure roller 42 are cylindrically-shaped, and are arranged such that the peripheral surfaces thereof are positioned side by side on opposite sides of the paper transport path Q. The rotation axes of the fixing roller 41 and the pressure roller 42 extend along a paper width direction, that is, along the front-back direction of the image forming apparatus 1. The fixing roller 41 and the pressure roller 42 have lengths that correspond to the whole area of the paper transport path Q in the paper width direction. The fixing roller 41 and the pressure roller 42 have a laminate structure that includes, for example, a release layer (e.g., a fluorine coating), a heating layer, and an elastic layer in that order from the outer peripheral surface toward the radial center.

A rotation shaft 41a of the fixing roller 41 is rotatably supported by a bearing mounted on a housing of the fixing part 40. The fixing roller 41 rotates in a clockwise direction in FIG. 2 powered by a motor (not shown). A rotation shaft 42a of the pressure roller 42 is rotatably supported by a bearing mounted on the housing of the fixing part 40. The pressure roller 42 rotates in a counterclockwise direction in FIG. 2 powered by a motor (not shown).

A predetermined pressure is applied to the pressure roller 42 by a pressurizing mechanism (not shown) that uses a pressurizing spring, or the like, and the peripheral surface of the pressure roller 42 is pressed against and contacts the peripheral surface of the fixing roller 41 to form a fixing nip N.

The heated roller 43 is cylindrically-shaped and houses the heating unit 45 for heating the heated roller 43 therein. The heated roller 43 is arranged such that a peripheral surface thereof is positioned opposite and apart from the peripheral surface of the fixing roller 41. The rotation axis of the heated roller 43 is parallel to the rotation axis of the fixing roller 41 and extends along the paper width direction, that is, along the front-back direction of the image forming apparatus 1. The heated roller 43 has a length that corresponds to the whole area of the paper transport path Q in the paper width direction. A rotation shaft (not shown) of the heated roller 43 is rotatably supported by a bearing mounted on the housing of the fixing part 40. The heated roller 43 is supported to be movable toward and away from the fixing roller 41.

The fixing belt 44 is formed endless, having a length in the paper width direction that is equal to the lengths of the fixing roller 41 and the heated roller 43. The fixing belt 44 has a laminate structure which includes, for example, a substrate layer such as of a polyimide film, an elastic layer, and a release layer. The fixing belt 44 is wound around the fixing roller 41 and the heated roller 43, and is sandwiched between the fixing roller 41 and the pressure roller 42 at the fixing nip N. A biasing force is applied to the heated roller 43 in a direction in which the heated roller 43 moves away from the fixing roller 41 to provide a predetermined tension to the fixing belt 44.

The fixing belt 44 is heated by the heating unit 45 via the heated roller 43. The fixing part 40 fixes, on the sheet of paper P, an unfixed toner image transferred to the sheet of paper P, at the fixing nip N where the fixing roller 41 contacts the pressure roller 42 on the opposite side of the heated fixing belt 44.

The temperature sensor 46 is mounted in close proximity to the fixing roller 41. The temperature sensor 47 is mounted in close proximity to the pressure roller 42. The temperature sensors 46 and 47 include, for example, a thermistor, and detect the temperatures of the surfaces of the fixing belt 44 and the pressure roller 42, respectively. The main controller 5 controls the heating unit 45 based on these temperatures.

The blower 50 includes a duct 51, a fan 52, and a filter 53 as shown in FIG. 2.

The duct 51 extends from below the pressure roller 42 to the left-side surface of the body of the image forming apparatus 1. The duct 51 has an inner opening 51a and an outer opening 51b. The inner opening 51a is provided at one end of the duct 51 on the side of the pressure roller 42 and faces the pressure roller 42. The outer opening 51b is provided at one end of the duct 51 on the left-side surface side of the image forming apparatus 1 spaced apart from the pressure roller 42. That is, the duct 51 extends between the inner opening 51a and the outer opening 51b.

The fan 52 is disposed inside the duct 51 in a substantially intermediate portion between the inner opening 51a and the outer opening 51b. When the fan 52 is driven, air flows inside the duct 51. The fan 52 is also capable of changing a flow direction of air by switching a rotation direction thereof. Thus, inside the duct 51, the air flows in a direction to draw the air into the duct 51 from the inner opening 51a, and in a direction to blow the air inside the duct 51 toward the pressure roller 42 from the inner opening 51a.

The filter 53 is disposed inside the duct 51 near one end of the duct 51 on the left-side surface side of the image forming apparatus 1. The filter 53 collects the particulates (UFP) that flow inside the duct 51.

FIG. 3 shows the relationship between the temperature of the heated roller 43 and the particulate (UFP) generation rate. According to FIG. 3, after about 30 seconds from the start of heating the heated roller 43 by the heating unit 45, the heated roller 43 reaches near a predetermined set temperature (about 200° C.). It can be seen that, after about one minute from the start of heating the heated roller 43, the generation rate of the particulates (UFP) is maximized.

It has been known that, for example, a silicone rubber material which forms the elastic layer of the heated roller 43 generates siloxane from axial end portions of rollers in the form of particulates (UFP). The amount of siloxane increases sharply when the temperature of the heated roller 43 reaches about 180° C. after heating of the heated roller 43 has started. It is thus desirable to drive the blower 50 to draw in and collect the particulates (UFP) suspended around the fixing part 40 during the early stages of the heating of the heated roller 43.

FIG. 4 is a timing diagram of the start of operation of the image forming apparatus 1, and shows, starting from the top, ON/OFF switching of the device power source, particulate (UFP) generation rate, temperature of the heated roller 43, temperature of an axial center portion of the pressure roller 42, temperature of axial end portions of the pressure roller 42, output/rotation direction of the fan 52, and start (ON)/stop (OFF) of the passing of sheets of paper.

As shown in FIG. 4, when the power source is turned on (time t0), the image forming apparatus 1 rotates the fan 52 in a reverse direction at a predetermined output. It should be noted that a forward rotation of the fan 52 is the rotation direction that causes the air to flow in a direction to blow the air inside the duct 51 toward the pressure roller 42 from the inner opening 51a, and a reverse rotation of the fan 52 is the rotation direction that causes the air to flow in a direction to draw the air into the duct 51 from the inner opening 51a.

When the power source of the image forming apparatus 1 is turned on, the heating of the heated roller 43 by the heating unit 45 starts and the temperature of the heated roller 43, the temperature of the axial center portion of the pressure roller 42, and the temperature of the axial end portions of the pressure roller 42 begin to rise. The temperature of the heated roller 43 heated by the heating unit 45 is controlled based on upper limit temperatures Uc and Ue of the pressure roller 42.

When the temperature of the heated roller 43 approaches a predetermined temperature (e.g., 180° C.), the particulate (UFP) generation rate increases to a peak. To address this problem, the fan 52 is rotated in the direction to draw air into the duct 51 from the inner opening 51a upon the start of heating (time t0) of the heated roller 43, and thus the particulates (UFP) can be collected by the filter 53.

The passing of the sheets of paper is then started (ON), for example, at time t1.

At a predetermined timing, time t2, the rotation of the fan 52 is switched to the forward rotation. That is, the fan 52 causes the air to flow in the direction to blow the air inside the duct 51 toward the pressure roller 42 from the inner opening 51a. Time t2 is predetermined as the time at which the particulate (UFP) generation rate drops to a certain level after the generation rate has peaked, and is stored in advance, for example, in the memory of the main controller 5, or the like.

Upon the forward rotation of the fan 52 at a predetermined output, the air inside the duct 51 is blown toward the pressure roller 42 from the inner opening 51a.

According to the configuration of the first embodiment, the image forming apparatus 1 rotates the fan 52 in the direction to draw the air into the duct 51 from the inner opening 51a at the start of heating (time t0) of the heated roller 43, and at the predetermined timing (time t2), switches the rotation direction of the fan 52 to the direction to blow the air inside the duct 51 toward the pressure roller 42 from the inner opening 51a. This enables the particulates to be collected by the filter 53 from the start of generation of the particulates to the peaking of the generation rate, and until the generation rate drops. Thereafter, the air is blown toward the pressure roller 42 from the duct 51 to cool the pressure roller 42. Thus, the particulates can efficiently be collected and the pressure roller 42 can effectively be cooled.

### Second Embodiment

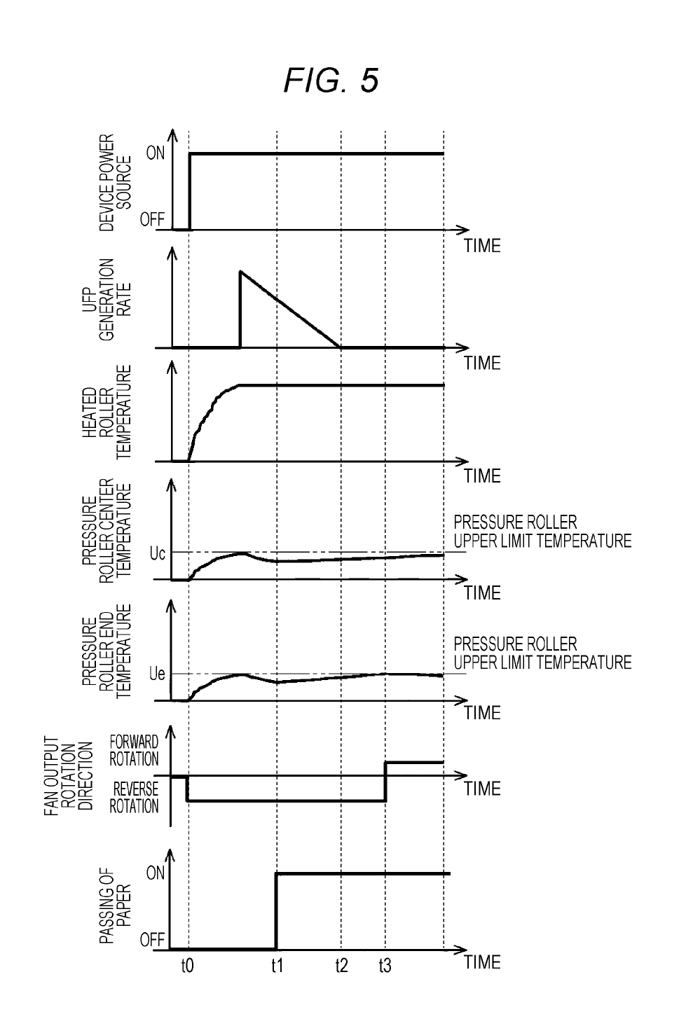

An image forming apparatus of a second embodiment of the present invention will now be described with reference to FIG. 5. FIG. 5 is a timing diagram of the start of operation of the image forming apparatus. Since the basic configuration of this embodiment is the same as that of the first embodiment described above, elements that are common with the first embodiment will be given identical names and reference numerals, and a detailed description thereof may be omitted.

As shown in FIG. 5, an image forming apparatus 1 of the second embodiment rotates a fan 52 in a reverse direction at a predetermined output when the power source is turned on (time t0) at the start of operation. This causes the fan 52 to direct air to flow in a direction to draw air into a duct 51 from an inner opening 51a.

The rotation direction of the fan 52 is not switched at time t2 at which the particulate (UFP) generation rate is expected to decrease.

After time t2 has passed, the rotation of the fan 52 is switched to the forward rotation at time t3, which is the timing at which the temperature of axial end portions of a pressure roller 42 reaches a predetermined upper limit temperature Ue. That is, the fan 52 causes the air to flow in a direction to blow the air inside the duct 51 toward the pressure roller 42 from the inner opening 51a.

The image forming apparatus 1 of the second embodiment thus switches the rotation direction of the fan 52 in the direction to blow the air inside the duct 51 toward the pressure roller 42 from the inner opening 51a based on the temperature of the pressure roller 42 detected by a temperature sensor 47. This configuration enables particulates to be collected by a filter 53 until the generation rate of the particulates drops sufficiently. Thus, the particulate collection effect by the blower 50 is improved.

In the image forming apparatus 1 of the second embodiment, the fixing member whose temperature is detected by the temperature sensor 47 is the pressure roller 42, and the duct 51 blows the air therein toward the pressure roller 42. This configuration enables the temperature of the whole pressure roller 42 to be uniform and ensures that the temperature of the whole pressure roller 42 does not rise excessively. The generation of image noise on a printed matter can thus be prevented. Cooling the pressure roller 42 also makes it possible to suppress variations in the fixing nip width caused by thermal expansion of the pressure roller 42 and to suppress degradation of the pressure roller 42.

### Third Embodiment

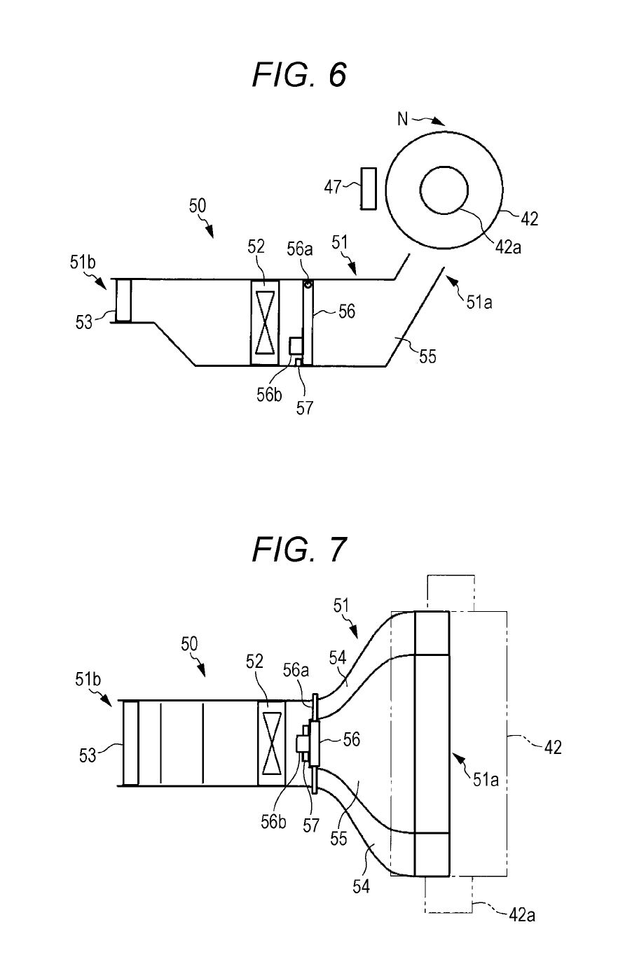

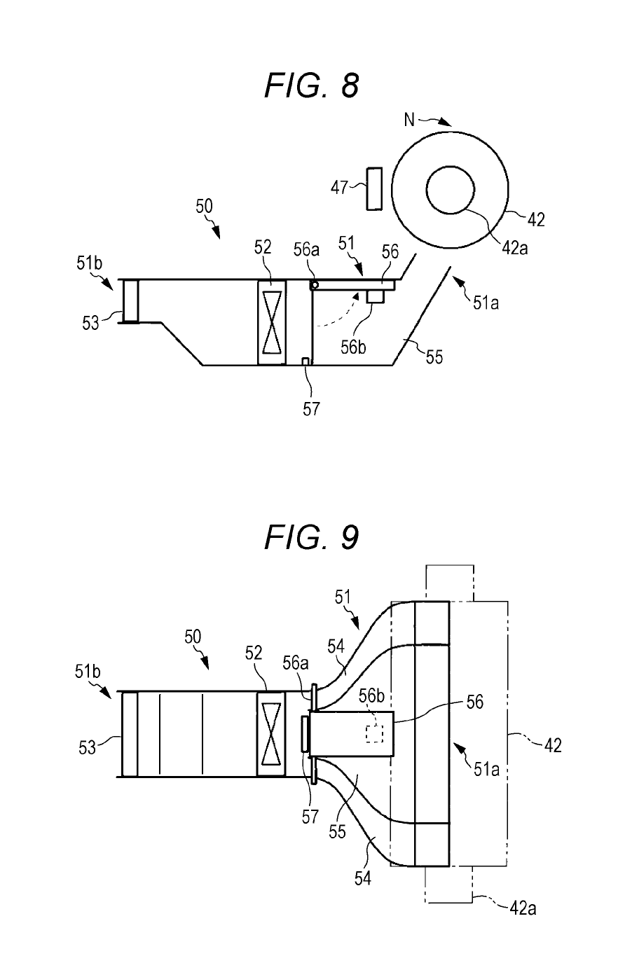

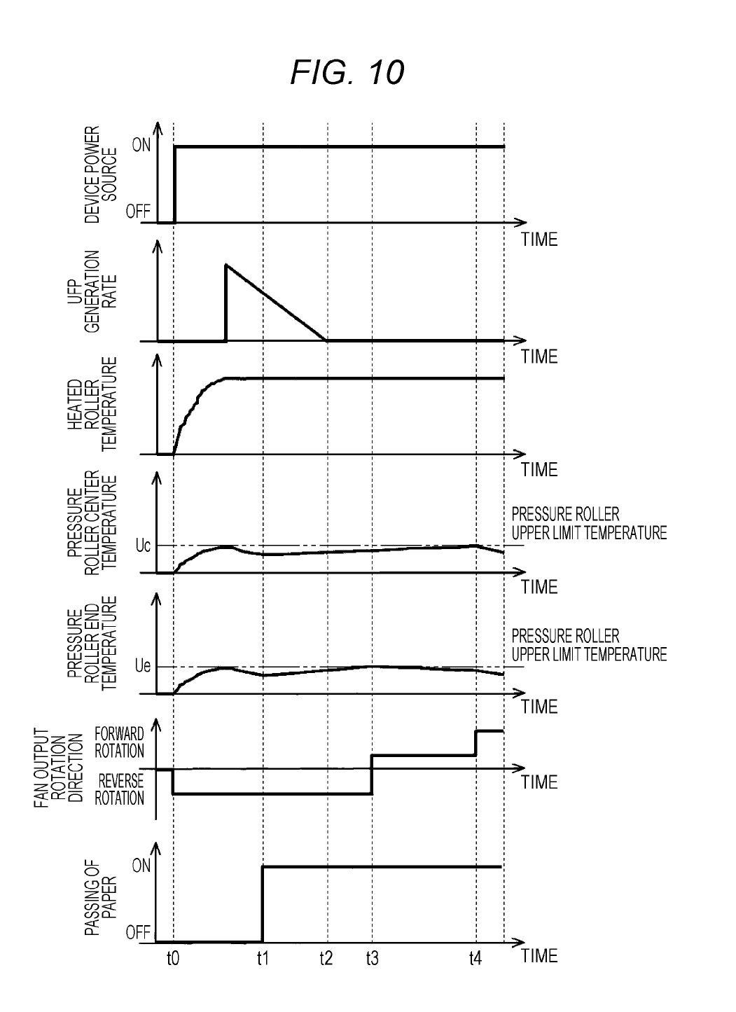

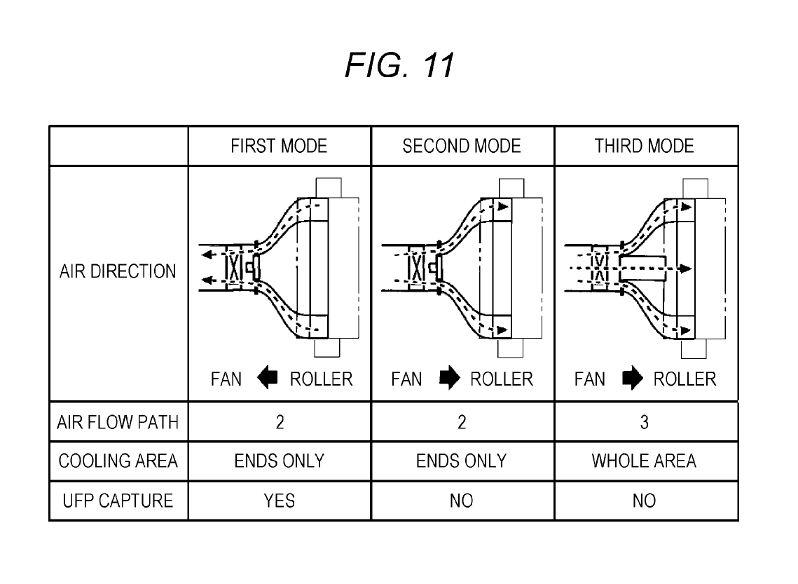

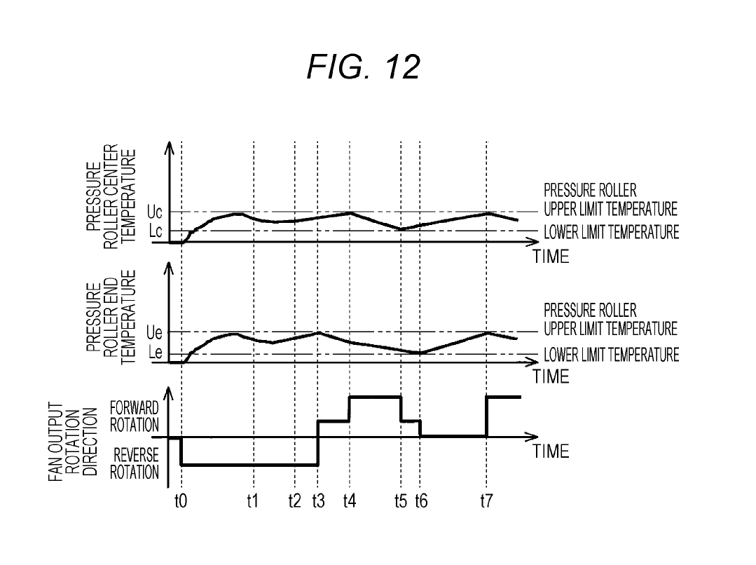

An image forming apparatus of a third embodiment of the present invention will now be described with reference to FIGS. 6 to 12. FIGS. 6 and 7 are a partial front view and a top view, respectively, showing a fixing part and a blower (in an inner valve closed state) of the image forming apparatus. FIGS. 8 and 9 are a partial front view and a top view, respectively, showing the fixing part and the blower (in an inner valve open state) of the image forming apparatus. FIG. 10 is a timing diagram of the start of operation of the image forming apparatus. FIG. 11 is a diagram showing operating modes of the blower. FIG. 12 is a timing diagram during steady-state operation of the image forming apparatus. Since the basic configuration of this embodiment is the same as those of the first and second embodiments described above, elements that are common with the first and second embodiments will be given identical names and reference numerals, and a detailed description thereof may be omitted.

As shown in FIGS. 6 to 9, a blower 50 of an image forming apparatus 1 of the third embodiment has a duct 51 that includes a plurality of inner air flow paths 54 and 55 and an inner valve 56.

The plurality of inner air flow paths 54 and 55 extends between an inner opening 51a and a fan 52. The plurality of inner air flow paths 54 and 55 is formed by the interior of the duct 51 being partitioned in an axial direction (front-back direction) of a pressure roller 42.

The two inner air flow paths 54 are provided respectively on axial end sides of the pressure roller 42. The two inner air flow paths 54 respectively face axial end portions of the pressure roller 42 at the inner opening 51a.

The single inner air flow path 55 is sandwiched between the two inner air flow paths 54, and is provided corresponding to an axial center portion of the pressure roller 42. The inner air flow path 55 faces the axial center portion of the pressure roller 42 at the inner opening 51a.

The inner valve 56 is mounted on the inner air flow path 55. The inner valve 56 is disposed at an end of the inner air flow path 55 on the side of a fan 52. The inner valve 56 is, for example, planar, and has substantially the same size and shape as the internal cross-section of the inner air flow path 55 in a direction transverse to the air flow direction thereof. The inner valve 56 is rotatably supported about a shaft 56a that is mounted on an upper end thereof and that extends in the axial direction of the pressure roller 42. When the inner valve 56 is in a substantially vertical position, the inner air flow path 55 is closed (see FIGS. 6 and 7). When the inner valve 56 rotates about the shaft 56a from this position, the inner air flow path 55 is opened (see FIGS. 8 and 9).

The inner valve 56 has a weight 56b. The weight 56b is disposed on a free end of the inner valve 56, that is, on a lower portion of the inner valve 56 in the substantially vertical closed position. The weight 56b functions as an inner valve biasing member for biasing the inner valve 56 in a direction to close the inner valve 56 under the force of gravity. A stopper 57 is mounted on an inner bottom face of the duct 51 on the fan 52 side of the inner valve 56 in the closed position. This prevents the inner valve 56 in the closed position from opening toward the fan 52. The inner valve 56 opens toward the inner opening 51a as shown in FIGS. 8 and 9.

As shown in FIG. 10, the image forming apparatus 1 rotates the fan 52 in a reverse direction at a predetermined output when the power source is turned on (time t0) at the start of operation. This causes the fan 52 to direct air to flow in a direction to draw air into the duct 51 from the inner opening 51a.

Although the fan 52 causes the air inside the duct 51 to flow in a direction to pull the inner valve 56, the inner valve 56 maintains the closed position due to the action of the stopper 57. The air thus flows from the inner opening 51a toward the fan 52 through the two inner air flow paths 54 that respectively face the axial end portions of the pressure roller 42. The filter 53 then collects particulates (UFP).

After time t2, at which the particulate (UFP) generation rate is expected to decrease, has passed, the rotation of the fan 52 is switched to the forward rotation at time t3, which is the timing at which the temperature of the axial end portions of the pressure roller 42 reaches a predetermined upper limit temperature Ue. That is, the fan 52 causes the air to flow in a direction to blow the air inside the duct 51 toward the pressure roller 42 from the inner opening 51a.

At time t3, the fan 52 is rotated at an output level low enough not to cause the inner valve 56 having the weight 56b to open, due to the weight thereof. That is, the inner valve 56 maintains the closed position by its own weight. The air thus flows from the fan 52 toward the inner opening 51a through the two inner air flow paths 54. Consequently, the air inside the duct 51 is blown toward the end portions of the pressure roller 42 from the inner opening 51a.

The rotation output of the fan 52 is then increased at time t4, which is the timing at which the temperature of the axial center portion of the pressure roller 42 reaches a predetermined upper limit temperature Uc. The fan 52 is rotated at an output level sufficient to open the inner valve 56 against the weight of the inner valve 56 having the weight 56b. The air thus flows from the fan 52 toward the inner opening 51a through the two inner air flow paths 54 and the single inner air flow path 55. The air inside the duct 51 flows from the inner opening 51a toward the end portions and the center portion of the pressure roller 42, that is, toward the whole axial area of the pressure roller 42.

The image forming apparatus 1 of the third embodiment thus switches between blowing the air toward the axial end portions of the pressure roller 42 and blowing the air toward the whole axial area of the pressure roller 42 by opening and closing the inner valve 56. The image forming apparatus 1 includes three operating modes as shown in FIG. 11.

In the first mode, the duct 51 draws air therein from the inner opening 51a. In the first mode, the air flows through the two inner air flow paths 54, only the axial end portions of the pressure roller 42 are cooled, and particulates (UFP) are collected by the filter 53.

In the second mode, the duct 51 blows air toward the axial end portions of the pressure roller 42. In the second mode, the air flows through the two inner air flow paths 54, only the axial end portions of the pressure roller 42 are cooled, and particulates (UFP) are not collected.

In the third mode, the duct 51 blows air toward the whole axial area of the pressure roller 42. In the third mode, the air flows through the three inner air flow paths 54 and 55, the whole axial area of the pressure roller 42 is cooled, and particulates (UFP) are not collected.

This configuration enables the axial end portions and the whole axial area of the pressure roller 42 to be cooled in stages. Thus, the whole area of the pressure roller 42 is effectively cooled by focusing on cooling the end portions of the pressure roller 42 the temperature of which tends to rise easily when, for example, sheets of paper of a relatively small size are continuously printed.

Additionally, the image forming apparatus 1 of the third embodiment opens and closes the inner valve 56 and switches the areas of the pressure roller 42 to which the air is blown based on the temperature of the pressure roller 42 detected by a temperature sensor 47. This configuration enables the axial end portions and the whole axial area of the pressure roller 42 to be cooled in stages according to the temperature of each area. Thus, the end portions and the whole area of the pressure roller 42 can be cooled at suitable timings so that the whole area of the pressure roller 42 can be cooled more effectively.

Furthermore, the image forming apparatus 1 of the third embodiment opens and closes the inner valve 56 having the weight 56b that biases the inner valve 56 in the direction to close the inner valve 56, based on the rotation output of the fan 52 and the rotation direction of the fan 52. This configuration enables the inner valve 56 to be opened and closed easily by simply changing the rotation output of the fan 52 and the rotation direction of the fan 52.

Once the operation of the image forming apparatus 1 is started, the rotation of the fan 52 is controlled as shown in FIG. 12 during steady-state operation after cooling of the whole axial area of the pressure roller 42 has started (after time t4). That is, when the whole area of the pressure roller 42 is cooled by the rotation of the fan 52 and the temperature of the axial center portion of the pressure roller 42 reaches a predetermined lower limit temperature Lc (time t5), the rotation output of the fan 52 is reduced. Consequently, the inner valve 56 is closed and the air inside the duct 51 is blown toward the end portions of the pressure roller 42 from the inner opening 51a.

Additionally, when the temperature of the axial end portions of the pressure roller 42 reaches a predetermined lower limit temperature Le (time t6), the rotation of the fan 52 is stopped. This stops the air flow inside the duct 51.

The whole area of the pressure roller 42 is then heated due to the cessation of rotation of the fan 52, and when the temperature of the axial center portion of the pressure roller 42 reaches a predetermined upper limit temperature Uc (time t7), the fan 52 is rotated forward at high output. Consequently, the inner valve 56 is opened and the air inside the duct 51 is blown toward the whole area of the pressure roller 42 from the inner opening 51a. This operation is repeated during subsequent steady state operation.

### Fourth Embodiment

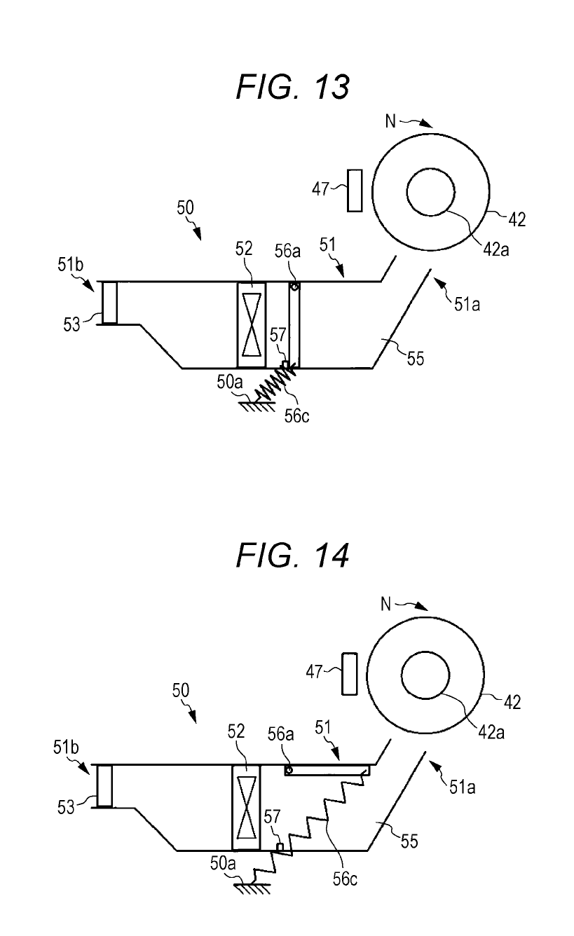

An image forming apparatus of a fourth embodiment of the present invention will now be described with reference to FIGS. 13 and 14. FIG. 13 is a partial front view showing a fixing part and a blower (in an inner valve closed state) of the image forming apparatus. FIG. 14 is a partial front view showing the fixing part and the blower (in an inner valve open state) of the image forming apparatus. Since the basic configuration of this embodiment is the same as that of the third embodiment described above, elements that are common with the third embodiment will be given identical names and reference numerals, and a detailed description thereof may be omitted.

As shown in FIGS. 13 and 14, a blower 50 of an image forming apparatus 1 of the fourth embodiment includes a duct 51 that has an inner valve 56.

A spring 56c is connected to the inner valve 56. The spring 56c is configured with an extension spring, and is coupled between a free end of the inner valve 56, that is, a lower portion of the inner valve 56 in a substantially vertical closed position, and a housing 50a of the blower 50. The spring 56c functions as an inner valve biasing member for biasing the inner valve 56 in a direction to close the inner valve 56 by an elastic force thereof.

This configuration also enables the inner valve 56 to be opened and closed easily by simply changing the rotation output of the fan 52 and the rotation direction of the fan 52.

### Fifth Embodiment

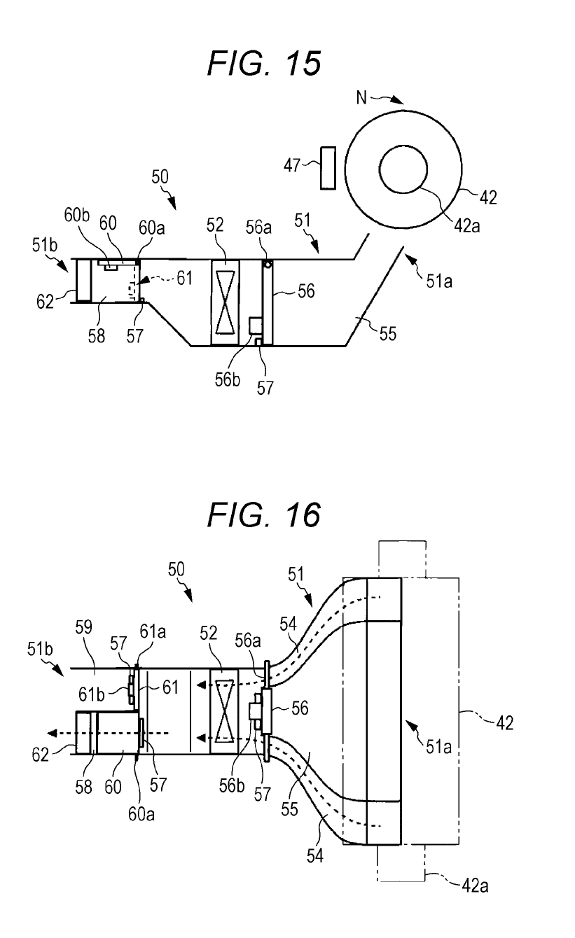

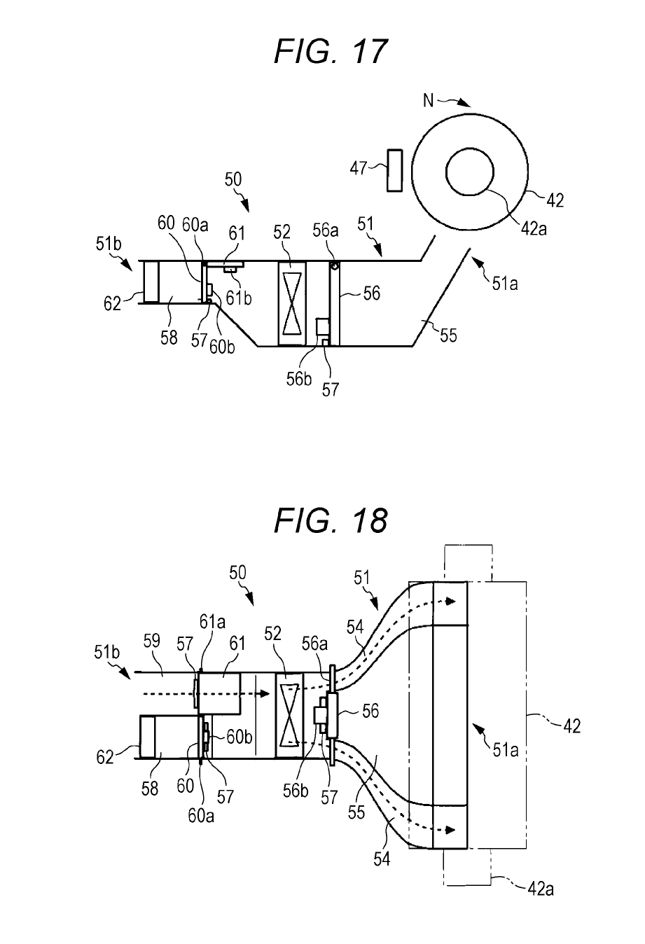

An image forming apparatus of a fifth embodiment of the present invention will now be described with reference to FIGS. 15 to 18. FIGS. 15 and 16 are a partial front view and a top view, respectively, showing a fixing part and a blower (in a first outer valve open state) of the image forming apparatus. FIGS. 17 and 18 are a partial front view and a top view, respectively, showing the fixing part and the blower (in a second outer valve open state) of the image forming apparatus. Since the basic configuration of this embodiment is the same as that of the third embodiment described above, elements that are common with the third embodiment will be given identical names and reference numerals, and a detailed description thereof may be omitted.

As shown in FIGS. 15 to 18, a blower 50 of an image forming apparatus 1 of the fifth embodiment includes a duct 51 that has a first outer air flow path 58, a second outer air flow path 59, a first outer valve 60, a second outer valve 61, and a filter 62.

The first outer air flow path 58 and the second outer air flow path 59 extend between a fan 52 and an outer opening 51b. The first outer air flow path 58 and the second outer air flow path 59 are formed by the interior of the duct 51 being partitioned in an axial direction (front-back direction) of a pressure roller 42.

The first outer valve 60 is mounted on the first outer air flow path 58. The first outer valve 60 is disposed at an end of the first outer air flow path 58 on the side of the fan 52. The first outer valve 60 is, for example, planar, and has substantially the same size and shape as the internal cross-section of the first outer air flow path 58 in a direction transverse to the air flow direction thereof. The first outer valve 60 is rotatably supported about a shaft 60a that is mounted on an upper end thereof and that extends in the axial direction of the pressure roller 42. When the first outer valve 60 is in a substantially vertical position, the first outer air flow path 58 is closed (see FIGS. 17 and 18). When the first outer valve 60 rotates about the shaft 60a from this position, the first outer air flow path 58 is opened (see FIGS. 15 and 16).

The first outer valve 60 has a weight 60b. The weight 60b is disposed on a free end of the first outer valve 60, that is, on a lower portion of the first outer valve 60 in a substantially vertical closed position. The weight 60b functions as an outer valve biasing member for biasing the first outer valve 60 in a direction to close the first outer valve 60 under the force of gravity. A stopper 57 is mounted on an inner bottom face of the duct 51 on the fan 52 side of the first outer valve 60 in the closed position. This prevents the first outer valve 60 in the closed position from opening toward the fan 52. The first outer valve 60 opens toward the outer opening 51b as shown in FIGS. 15 and 16.

The second outer valve 61 is mounted on the second outer air flow path 59. The second outer valve 61 is disposed at an end of the second outer air flow path 59 on the side of the fan 52. The second outer valve 61 is, for example, planar, and has substantially the same size and shape as the internal cross-section of the second outer air flow path 59 in a direction transverse to the air flow direction thereof. The second outer valve 61 is rotatably supported about a shaft 61a that is mounted on an upper end thereof and that extends in the axial direction of the pressure roller 42. When the second outer valve 61 is in a substantially vertical position, the second outer air flow path 59 is closed (see FIGS. 15 and 16). When the second outer valve 61 rotates about the shaft 61a from this position, the second outer air flow path 59 is opened (see FIGS. 17 and 18).

The second outer valve 61 has a weight 61b. The weight 61b is disposed on a free end of the second outer valve 61, that is, on a lower portion of the second outer valve 61 in a substantially vertical closed position. The weight 61b functions as an outer valve biasing member for biasing the second outer valve 61 in a direction to close the second outer valve 61 under the force of gravity. A stopper 57 is mounted on an inner bottom face of the duct 51 on the outer opening 51b side of the second outer valve 61 in the closed position. This prevents the second outer valve 61 in the closed position from opening toward the outer opening 51b. The second outer valve 61 opens toward the fan 52 as shown in FIGS. 17 and 18.

The filter 62 is disposed inside the first outer air flow path 58 near one end of the first outer air flow path 58 on the left-side surface side of the image forming apparatus 1. The filter 62 collects particulates (UFP) that flow inside the first outer air flow path 58.

The image forming apparatus 1 rotates the fan 52 in a reverse direction at a predetermined output when the power source is turned on at the start of operation. This causes the fan 52 to direct air to flow in a direction to draw air into the duct 51 from the inner opening 51a.

The air inside the duct 51 flows in a direction in which the fan 52 pushes the first outer valve 60 and the second outer valve 61. The first outer valve 60 is thus opened, and the air inside the first outer air flow path 58 flows from the fan 52 toward the outer opening 51b (see FIGS. 15 and 16). The filter 62 then collects the particulates (UFP).

Meanwhile, the second outer valve 61 maintains the closed position by the action of the stopper 57 and prevents air from flowing inside the second outer air flow path 59.

After a time has passed at which the particulate (UFP) generation rate is expected to decrease, the rotation of the fan 52 is switched to the forward rotation at a timing at which the temperature of axial end portions of the pressure roller 42 reaches a predetermined upper limit temperature Ue. That is, the fan 52 causes the air to flow in a direction to blow the air inside the duct 51 toward the pressure roller 42 from the inner opening 51a.

The air inside the duct 51 flows in a direction in which the fan 52 pulls the first outer valve 60 and the second outer valve 61. The second outer valve 61 is thus opened and the air inside the second outer air flow path 59 flows from the outer opening 51b toward the fan 52 (see FIGS. 17 and 18). Consequently, the air inside the duct 51 is blown toward the end portions of the pressure roller 42 from the inner opening 51a.

Meanwhile, the first outer valve 60 maintains the closed position by the action of the stopper 57 and prevents air from flowing inside the first outer air flow path 58.

The image forming apparatus 1 of the fifth embodiment thus opens the first outer valve 60 and closes the second outer valve 61 when directing air to flow from the fan 52 toward the outer opening 51b, and closes the first outer valve 60 and opens the second outer valve 61 when directing the air to flow from the outer opening 51b toward the fan 52. This configuration makes it possible to prevent the particulates collected by the filter 62 from being scattered toward the pressure roller 42 when the air is blown toward the pressure roller 42. As a result, the particulates can more efficiently be collected. Additionally, since the air constantly flows toward the filter 62 in a direction to adequately collect the particulates, rapid degradation of the filter 62 is prevented.

Furthermore, the image forming apparatus 1 of the fifth embodiment opens and closes the first outer valve 60 having the weight 60b that biases the first outer valve 60 in the direction to close the first outer valve 60 and the second outer valve 61 having the weight 61b that biases the second outer valve 61 in the direction to close the second outer valve 61, based on the rotation direction of the fan 52. This configuration enables the first outer valve 60 and the second outer valve 61 to be opened and closed easily by simply changing the rotation direction of the fan 52.

While the embodiments of the present invention have been described above, the scope of the invention is not limited thereto, and the invention can be implemented with modifications without departing from the spirit of the invention.

For example, although in the above embodiments, the inner valve biasing member and the outer valve biasing member of the inner valve 56, the first outer valve 60, and the second outer valve 61 are configured with a weight or an extension spring, these biasing members are not limited to a weight or an extension spring. For example, a helical torsion spring may be mounted on each shaft of the inner valve 56, the first outer valve 60, and the second outer valve 61. The valves may also be biased in a direction to close the valves by their own weights only. As an alternative to the biasing members, the inner valve 56, the first outer valve 60, and the second outer valve 61 may be opened and closed at predetermined timings using a drive source such as a motor or a solenoid.

Furthermore, although in the above embodiments, the image forming apparatus 1 is a tandem color image forming apparatus, the image forming apparatus is not limited to this type, and may be a non-tandem color image forming apparatus or a black and white image forming apparatus.

The present invention may be used in image forming apparatuses.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a fixing part that fixes an unfixed toner image transferred to a sheet of paper by a fixing member being heated;
a duct having an inner opening facing the fixing member and an outer opening spaced apart from the fixing member;
a fan capable of changing a flow direction of air inside the duct;
a filter that collects particulates flowing inside the duct; and
a hardware processor that controls the fan to rotate in a direction to draw air into the duct from the inner opening to collect the particulates from a vicinity of the fixing member, and that, at a timing at which to cool the fixing member, controls the fan to rotate in a direction to blow air inside the duct toward the fixing member from the inner opening.

2. The image forming apparatus according to claim 1, further comprising a temperature sensor that detects a temperature of the fixing member,
wherein the hardware processor controls the fan to rotate in the direction to blow the air inside the duct toward the fixing member from the inner opening based on the temperature of the fixing member detected by the temperature sensor.

3. The image forming apparatus according to claim 1, wherein the duct includes:
a plurality of inner air flow paths extending between the inner opening and the fan and respectively facing axial end portions and an axial center portion of the fixing member at the inner opening; and
an inner valve mounted on at least one of the plurality of inner air flow paths and capable of opening and closing the at least one of the plurality of inner air flow paths,
wherein the inner valve is opened and closed to switch between blowing the air toward the axial end portions of the fixing member and blowing the air toward a whole axial area of the fixing member.

4. The image forming apparatus according to claim 3, further comprising a temperature sensor that detects a temperature of the fixing member,
wherein the inner valve is opened and closed to switch areas of the fixing member to which the air is blown based on the temperature of the fixing member detected by the temperature sensor.

5. The image forming apparatus according to claim 3, further comprising an inner valve biasing member that biases the inner valve in a direction to close the inner valve,
wherein the inner valve is opened and closed based on a rotation output of the fan and a rotation direction of the fan.

6. The image forming apparatus according to claim 3, comprising operational modes including a first mode in which the duct draws the air therein from the inner opening, a second mode in which the duct blows the air toward the axial end portions of the fixing member, and a third mode in which the duct blows the air toward the whole axial area of the fixing member.

7. The image forming apparatus according to claim 1, wherein the duct includes:
a first outer air flow path and a second outer air flow path extending between the fan and the outer opening;
a first outer valve and a second outer valve mounted respectively on the first outer air flow path and the second outer air flow path and capable of individually opening and closing the first outer air flow path and the second outer air flow path; and
the filter mounted on the first outer air flow path,
wherein the first outer valve is opened and the second outer valve is closed when the air is caused to flow from the fan toward the outer opening, and the first outer valve is closed and the second outer valve is opened when the air is caused to flow from the outer opening toward the fan.

8. The image forming apparatus according to claim 7, further comprising a plurality of outer valve biasing members that biases the first outer valve or the second outer valve in a direction to individually close the first outer valve or the second outer valve,
wherein the first outer valve or the second outer valve is individually opened and closed based on a rotation direction of the fan.

9. The image forming apparatus according to claim 2, wherein the fixing member whose temperature is detected by the temperature sensor is a pressure roller, and the duct blows the air therein toward the pressure roller.
